(19) United States
(12) Patent Application Publication
(10) Pub. No.: US 2006/0182944 A1
(43) Pub. Date: Aug. 17, 2006

(54) Flexible reticulated foam fluid treatment media and method of preparation

(75) Inventors: David Leavitt, Edmond, OK (US); John Famula, Severna Park, MD (US); Christer Broman, Millersville, MD (US); Jeremy Hess, Fayetteville, AR (US); Elmo Geppelt, Tulsa, OK (US)

Correspondence Address: DUNLAP, CODDING & ROGERS P.C., PO BOX 16370, OKLAHOMA CITY, OK, 73113, US

(73) Assignee: Fluid Treatment Systems, Inc.

(21) Appl. No.: 11/351,930

(22) Filed: Feb. 10, 2006

Related U.S. Application Data
(60) Provisional application No. 60/652,323, filed on Feb. 11, 2005.

(51) Int. Cl. B32B 3/26

(52) U.S. Cl. 428/304.4

(57) ABSTRACT

Flexible reticulated foam fluid treatment media and a method of making same. The flexible fluid treatment media includes a flexible reticulated foam substrate, a binder coating the flexible reticulated foam substrate and a plurality of particles compressed into the binder to form a durable interconnected layer of particles that are bound together and collectively fixed to the substrate. The flexible reticulated foam fluid treatment media is flexible and easily cut and shaped without damaging the particle layer to form a wide variety of shapes and sizes that lend themselves to use within an equally wide variety of pipes, conduits, ducts, skimmers, filter housings and fluid treatment devices. The method used to create the fluid treatment reticulated foam media includes the steps of coating a soft reticulated foam substrate with a binder, subjecting the coated substrate to compression forces, allowing the coated substrate surface to become tacky, coating the binder with a plurality of metal particles or metal oxides or activated carbon particles or intimate mixtures of these particles combined together, subjecting the coated substrate to compression forces using a roller or by passing the coated substrate between a pair of adjacent rollers, removing any excess metal particles, and curing the binder by air drying using ambient air or heated air, and removing any excess particles.

### CROSS-REFERENCE TO RELATED APPLICATIONS

This application claims benefit of provisional application U.S. Ser. No. 60/652,323, filed Feb. 22, 2005, entitled Flexible Reticulated Foam Fluid Treatment Media and Method of Preparation.

### FIELD OF THE INVENTION

The present invention relates generally to fluid treatment systems and more particularly, but not by way of limitation, to flexible reticulated foam media used in fluid treatment systems and the method for making the same.

### BACKGROUND OF THE INVENTION

Fluid treatment systems, devices and processes are necessary for purifying fluids such as water, air, gases and oil. Purified water is essential for human health and recreation, and for countless agricultural, industrial, military and medical applications. Polluted air and contaminated exhaust from combustion processes and effluent from chemical production can be harmful and must be treated to remove contaminants prior to release into the environment. Purification typically involves the removal or destruction or neutralization of harmful and undesirable biological and chemical substances present in water, air and other fluids.

Fluid treatment processes include filtration, chemical disinfection, oxidation and reduction, adsorption, electrochemical separation and neutralization. Contaminants are often removed from air and other gases by filtration, catalyzed destruction and/or adsorption onto a suitable media such as activated carbon. Water is commonly treated to remove micro-organisms, such as bacteria or algae, and harmful metal ions, such as mercury and lead. Potable water is prepared by filtration and chemical coagulation to remove solids and particulate matter followed by chemical disinfection to destroy pathogens. Water used in swimming pools and spas is also purified by filtration and chemical treatment. Chemicals such as chlorine, bromine, copper or silver ions are commonly used to disinfect and purify water. When used to purify water in swimming pools, spas and hot tubs chlorinated and brominated compounds are dangerous to the environment and can cause human health problems, including asthma in children and birth defects in pregnant women.

Metal particulates are also used for water treatment and treatment processes and are less hazardous to human health and less damaging to the environment than chlorine and bromine treatment. Metal particulates made from copper and zinc alloys have been used for many years to treat water containing bacteria and algae. U.S. Pat. No. 5,314,623 discloses a method for treating fluids that utilizes a bed of metal particles such as aluminum, steel, zinc, tin, copper, and mixtures and alloys thereof. Especially desirable results have been obtained where the metal particles are zinc and copper particles, which can be alloyed to form brass having the capability of undergoing oxidation/reduction reactions when exposed to water and other polar fluids that are useful in removing heavy metals from the fluids. Brass particulates can be used to catalytically destroy chlorine present in water and to selectively remove lead and mercury. Copper/zinc alloys containing other constituents, such as silver, are also reported to be effective bacteriostatic agents, and can be used to control bacteria in both air and water.

Metal particles, however, must be used in the form of packed beds of particles enclosed within a treatment device to provide suitable surface area and contact time for removal of the contaminants from a fluid. Because the metal particles are reactive, particles within the packed beds fuse together in the presence of the fluid or decompose to form fines that clog the bed and reduce porosity, resulting in a reduction of treatment efficiency and excessively high pressure drops through the bed or column of particles.

The prior art describes the use of copper/zinc alloys in the form of a metal reticulated foam media to provide effective fluid treatment without the need for a packed bed of metal particulates. The metal reticulated foam media preferably are of the type described in U.S. Pat. No. 5,552,058, entitled “Cooling Tower Water Treatment Method” filed by Fanning Apr. 21, 1994 and issued Sep. 3, 1996, and U.S. Pat. No. 5,599,457 entitled “Machine Coolant Treatment Method” filed by Fanning Apr. 21, 1994 and issued Feb. 4, 1997, and U.S. Pat. No. 5,622,627 entitled “Parts Washer System” filed by Fanning Apr. 21, 1994 and issued Apr. 22, 1997, and U.S. Pat. No. 5,599,456 entitled “Fluid Treatment Utilizing a Reticulated Foam Structured Media Consisting of Metal Particles” filed by Oct. 11, 1994 and issued Feb. 4, 1997, the disclosures of which are hereby expressly incorporated herein by reference.

The metal reticulated foam media shown in the above-referenced patents provides a high surface area for fluid treatment and a low pressure drop, allowing high flow rates and low restriction that facilitate oxidation/reduction reactions between the contaminants in the fluid and the media. Fluid treatment systems utilizing such reticulated foam media substantially remove and/or reduce the amount of contaminates, such as chlorine, dissolved heavy metal ions (arsenic, cadmium chromium VI, chromium III, selenium, and mercury), sulfur, iron and the like from a treated fluid. The metal reticulated foam media can also be used to control the growth of microorganisms, such as bacteria, algae and fungus, and to remove scale and minimize scale formation from the surfaces of conduits, pipes and ducts in contact with the treated fluid. Metal reticulated foam fluid treatment media can also contain silver and other metals. As shown in U.S. Pat. No. 6,395,168, a copper-zinc reticulated metal foam is disclosed that contains silver to enhance the disinfection capability of the media.

The rigid metal reticulated foam media described in U.S. Pat. Nos. 5,599,456; 5,599,457; 5,552,058; and 5,622,627, are prepared by mixing metal particles with a carrier and applying the mixture to foam structures also known as substrates made from various materials including polyethylene and polyester. The coated foam structures are then subjected to heat and pressure sufficient to decompose the underlying substrate and binder to form hard rigid sponge-like metal structures also known as metal reticulated foam media using methods for preparation of such media that are well known in the art and commercially available.

For example, U.S. Pat. No. 5,599,456 describes a method for preparing a durable and rigid metal foam media for use with both hot and ambient fluids whereby soft, intermediate stage copper slurry coated foam structures are heated in a furnace from approximately 1950° F. to about 2150° F. for a period of time effective to evaporate the polyethylene substrate foam and produce a rigid foam structure consisting of copper. During the heating of the copper slurry coated polyethylene substrate, the furnace is flooded with hydrogen gas. A second slurry mix consisting of a 200-mesh powder consisting of metal particles (KDF-55), a copper/zinc metal particulate commercially available from KDF, Inc. of Constantine, Mich. is then admixed with a binder and applied to the copper structure. The resulting structure is allowed to dry under ambient conditions and the resultant hardened structure is then placed in a furnace flooded with hydrogen gas and maintained at approximately 1950° F. to about 2150° F. for a period of time effective to sinter the copper/zinc alloy and to insure that any trace amounts of foreign material, such as binder and polyethylene, have been gassed off. After the sintering of the copper/zinc alloy has been completed and the impurities have been gassed off, the resultant rigid metal reticulated foam media is then allowed to cool at ambient temperatures.

Although rigid metal reticulated foam media is durable and stable, the processes shown in the prior art cannot make rigid reticulated foam media containing absorbents such as activated carbon mixed with metal particulates. Activated carbon would decompose along with the polymer substrate and the binder during the high temperature-heating step of the preparation process. For the same reason, the prior art cannot be used to prepare media containing heat sensitive catalyst materials such as ruthenium or copper/zinc alloys containing concentrations of zinc above 55% to 60% because these materials will volatilize from the coated surface when heated to the temperatures necessary to decompose the substrate.

Further, the prior art methods used to prepare rigid metal reticulated foam media require large investments in capital and equipment, and rigid reticulated foam media is not always required for fluid treatment if a durable and catalytically active soft and flexible metal coated reticulated foam can be made. It is to such a durable, catalytically active soft and flexible metal coated reticulated foam that the present invention is directed.

### SUMMARY OF THE INVENTION

An object of the present invention is to provide flexible reticulated fluid treatment media that is catalytically active and durable.

Another object of the invention, while achieving the before-stated object, is to provide flexible reticulated foam fluid treatment media wherein the particle layer bound to surfaces of a porous substrate can be varied in composition so that the flexible reticulated foam fluid treatment media is capable of promoting a wide variety of fluid treatment functions including oxidation/reduction reactions, catalytic reactions and chemical adsorption of contaminants in a fluid to be treated.

Yet another object of the present invention, while achieving the before-stated objects, is to provide an improved method for preparing flexible reticulated foam fluid treatment media that facilitates a strong and stable bond between the particulate material in the coating layer, the binder and the substrate.

These and other objects, advantages and features of the present invention will become apparent to those skilled in the art from a reading of the following disclosure, when read in conjunction with the drawings and appended claims.

According to the present invention, a method is provided for producing a flexible reticulated fluid treatment media. One aspect of the present invention is to provide a flexible copper/zinc reticulated foam media which is capable of removing scale, hard scale, chlorine, bacteria, algae and dissolved heavy metals from water found in pools, spas and hot tubs. The flexible copper/zinc reticulated foam media can be easily cut into shapes or configurations that conform to the dimensions of pool and spa skimmer baskets and inlet conduits and pipes. The flexible copper/zinc reticulated foam media is also capable of undergoing reduction/oxidation reactions to remove scale, hard scale, bacteria, algae and dissolved heavy metals from cooling tower waters and machine coolants.

Further, according to the present invention a flexible porous substrate is coated with a stable mixture of activated carbon and copper/zinc metal particles to provide a flexible reticulated foam fluid treatment media which can be used to treat fluids by the synergistic action of adsorption of contaminants onto the activated carbon and catalyzed oxidation/reduction of contaminants by the copper/zinc media.

In all aspects the reticulated foam media is soft, flexible, easily cut and shaped without damaging the particle layer. Thus, the flexible reticulated foam fluid treatment media can be provided with a wide variety of shapes and sizes that lend themselves to use within an equally wide variety of pipes, conduits, ducts, skimmers, filter housings and fluid treatment devices.

Broadly, the method for providing flexible reticulated foam fluid treatment media in accordance with the present invention includes the steps of coating a soft or flexible porous substrate with a binder, removing excess binder and thereby create a substantially uniform binder layer on the surface of the substrate, allowing the coated substrate surface to become tacky, coating the binder with a plurality of particles selected from the group consisting of metal particles, metal oxides particles, activated carbon particles and mixtures thereof, removing the excess particles, subjecting the coated substrate to compression forces using a roller or by passing the coated substrate between a pair of adjacent rollers, curing the binder by air drying using ambient air or heated air, and removing any excess particles lodged in the pores of the flexible reticulated foam media. During the curing phase the binder will continue to seep into the saturated particulate coating, forming a uniform, evenly distributed cured coating layer tightly and seamlessly bound to the surface of the substrate.

The method of preparation may also involve the compression of the reticulated foam substrate coated with a binder by means of a roller or pair of rollers whereby the force of the rollers presses the binder into the pores and irregular surfaces of the substrate, eliminating air pockets and insuring a strong, seamless and stable bond between the substrate and the binder. It may be also desirable to further compress the reticulated foam substrate coated with both the binder and the particulates by means of a roller or pair of rollers whereby the force of the rollers presses the coating layer containing the binder and the particulates together and into the substrate, forcing the binder into the irregular surface contours of the particulates, eliminating air pockets and insuring a strong and stable bond between the substrate and the coating layer. A commercial wringer device equipped with a pair of tension-adjustable rollers may be used for compression of the coated foam substrates.

During the compression steps, the coated reticulated foam substrate is optimally compressed by passing through the gap between two rollers where the thickness of the gap between the rollers when the substrate is coated is correlated to the amount of compression force applied to the coated substrate. The gap is set by a device that applies tension to the rollers so that the hill surface of one roller meshes with a valley surface of the adjacent roller to assist in feeding the coated substrate through the rollers. Adjusting the tension applied to the rollers controls the compression force applied to the substrate. The amount of compression force applied to the coated foam substrate is an important factor in the method of preparation because too little applied force would result in a unstable bond between the materials and too great an applied force could damage the coating materials and close off the open pores and void spaces inherent in the reticulated foam, thereby reducing the porosity and surface area of the media and its effectiveness for fluid treatment.

### BRIEF DESCRIPTION OF THE DRAWINGS

FIG. 1 is a pictorial representation of a flexible reticulated foam fluid treatment media constructed in accordance with the present invention.

FIG. 2 is a pictorial representation of a media pore showing a portion of a substrate, a binder and a plurality of particles disposed thereon.

FIG. 3 is a cross-sectional pictorial representation of the flexible reticulated foam fluid treatment media of the present invention.

FIG. 4 is a pictorial representation illustration of the flexible foam substrate during preparation of the flexible reticulated foam fluid treatment media of the present invention.

FIG. 5 is a block diagram showing preparation of the flexible reticulated foam fluid treatment media of the present invention.

### DETAILED DESCRIPTION

As previously stated, the method of preparation of a flexible reticulated foam fluid treatment media of the present invention involves the compression of the flexible porous substrate coated with a binder whereby the force of the compression presses the binder into the pores and irregular surfaces of the substrate, eliminating excess binder and eliminating air pockets and insuring a strong, seamless and stable bond between the substrate and the binder. It may be also desirable to further compress the reticulated foam substrate coated with both the binder and the particulates whereby the force of compression presses the coating layer containing the binder and the particulates together and into the substrate, forcing the binder into the irregular surface contours of the particulates, eliminating air pockets and insuring a strong and stable bond between the substrate and the coating layer. A commercial wringer device equipped with a pair of tension-adjustable rollers may be used for compression of the coated foam substrates.

During the compression steps, the coated reticulated foam substrate is optimally compressed by passing the coated reticulated foam substrate through the gap between two rollers where the thickness of the gap between the rollers is correlated to the amount of compression force applied to the coated substrate. The gap is set by a device that applies tension to the rollers so that the hill surface of one roller meshes with a valley surface of the adjacent roller to assist in feeding the coated substrate through the rollers. Adjusting the tension applied to the rollers controls the compression force applied to the substrate. The amount of compression force applied to the coated foam substrate is an important factor in the method of preparation because too little applied force would result in a unstable bond between the materials and too great an applied force could damage the coating materials and close off the open pores and void spaces inherent in the reticulated foam, thereby reducing the porosity and surface area of the media and its effectiveness for fluid treatment.

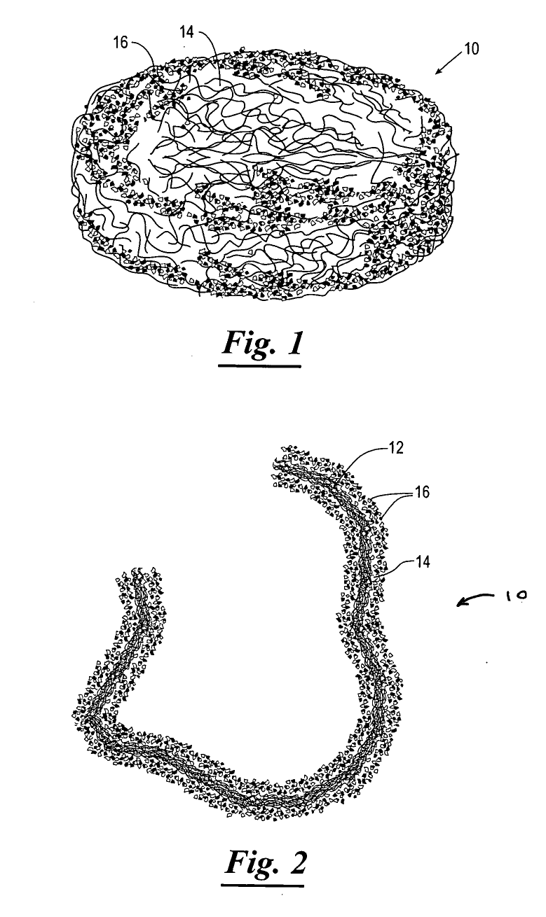

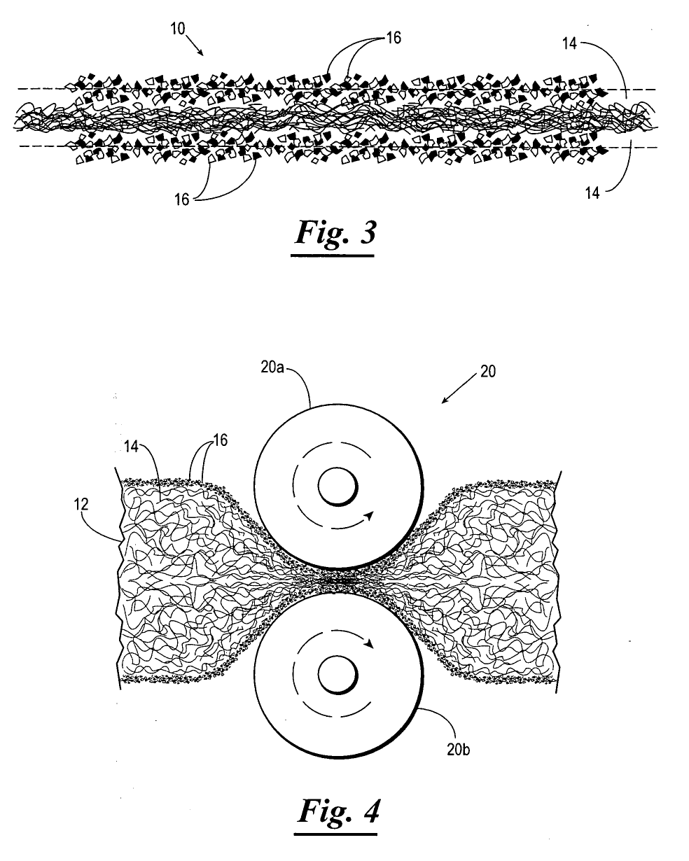

Referring now to the drawings, and more particularly to FIGS. 1-3, shown therein is a flexible reticulated foam fluid treatment media 10 constructed in accordance with the present invention. The flexible reticulated foam fluid treatment media 10 includes a flexible porous substrate 12 (also referred to herein as a flexible foam substrate), a binder 14 coating the flexible foam substrate 12, and a plurality of particles 16 compressed into the binder 14 to form a durable interconnected layer of particles 18 that are bound together and collectively fixed to the flexible foam substrate 12. The size and chemical make-up of the particles 16 compressed into the binder 14 will vary depending upon the intended use of the flexible foam substrate 12. That is, the size of the particles 16 can vary and will be dependent to a large extent on the fluid to be treated, as well as the flow rate of the fluid through the flexible reticulated foam fluid treatment media 10. Generally, however the average the size of the particles range from about 10 to about 400 mesh based on U.S. standard screen sizes and more desirably the particles have an average mesh size of about 180-220. Generally, the particles 16 are metal particles, metal oxide particles, activated carbon particles and combinations thereof.

The flexible foam substrate 12 employed in the flexible reticulated foam fluid treatment media 10 of the present invention can be fabricated of any flexible, porous material, such as polymeric or composite material that can provide the reticulated foam fluid treatment media 10 with the desired flexibility, stability, porosity and pore size. Examples of various flexible polymeric materials which can be employed as the flexible foam substrate 12 include, but are not limited to, polyethylene, polyether, polypropylene, polyurethane, polyester, polystyrene, polycarbonate, copolymers of acrylic and non-acrylic polymers, blends thereof, and the like. The number of pores per square inch of the flexible foam substrate 12 employed to produce the flexible reticulated foam fluid treatment media 10 can vary widely, desirable results have been obtained wherein the number of pores per square inch of the flexible foam substrate is from about 5 pores to about 30 pores per square inch. Similarly, the pore size of the pores in the flexible foam substrate 12 can vary widely and will generally be from about 10 microns to about a quarter of an inch when one cubic inch of the flexible foam substrate has a surface area of at least about 350 square inches. While any suitable plastic, polymeric or composite material having before defined characteristics can be employed as the flexible foam substrate 12, especially desirable results have been obtained where the flexible foam substrate 12 is produced from a polyethylene having the pore density, pore size and surface area as described above.

The binder 14 of the flexible reticulated foam fluid treatment media 10 can be any material compatible with the substrate 12, the particle 16 used in the construction of the flexible reticulated foam fluid treatment media 10, and the particular application for which the flexible reticulated foam fluid treatment media 10 is used. Examples of such binders include, but are not limited to, acrylic glue, polychloroprene cement, neoprene rubber cement, polychlorinated rubber adhesive, phenolic resin, resorcinol glue, phthalate ester adhesive, silicon glue, and polyurethane glue. One preferred binder for the flexible reticulated foam fluid treatment media 10 when same is used in applications involving treatment of contaminated water is polychloroprene cement; whereas another preferred material for use with potable water treatment systems is polyurethane glue.

The metal particles employed as the particles 16 in the practice of the present invention can be selected from a variety of materials including but not limited to, brass, bronze, copper, zinc, iron, iron oxide, silver, tin, nickel, nickel oxide, aluminum, alumina, platinum, palladium rhodium ruthenium, titanium, titania, manganese, manganese oxide and antimony. These particles can be used individually or combined together to form the metal coating. The preferred metal coating is formed from bimetallic and trimetallic mixtures containing copper and zinc.

The amount of particles 16 employed to provide the flexible reticulated foam fluid treatment media 10 of the present invention can vary widely and will generally be dependent upon the intended use of the flexible reticulated foam fluid treatment media 10. However, the amount of particles present on the flexible foam substrate will desirably range from about 10 to 65 weight percent.

The activated carbon particles employed in the practice of the present invention can be selected from any source of highly porous carbon, such as that derived from coal, pitch, coconut shells, corn husks, polyacrylonitrile (PAN) polymers, charred cellulosic fibers and wood.

When utilizing activate carbon as at least one of the particles 16, the amount of activated carbon present on the flexible foam substrate can vary widely but will generally be from about 5 to about 45 weight percent.

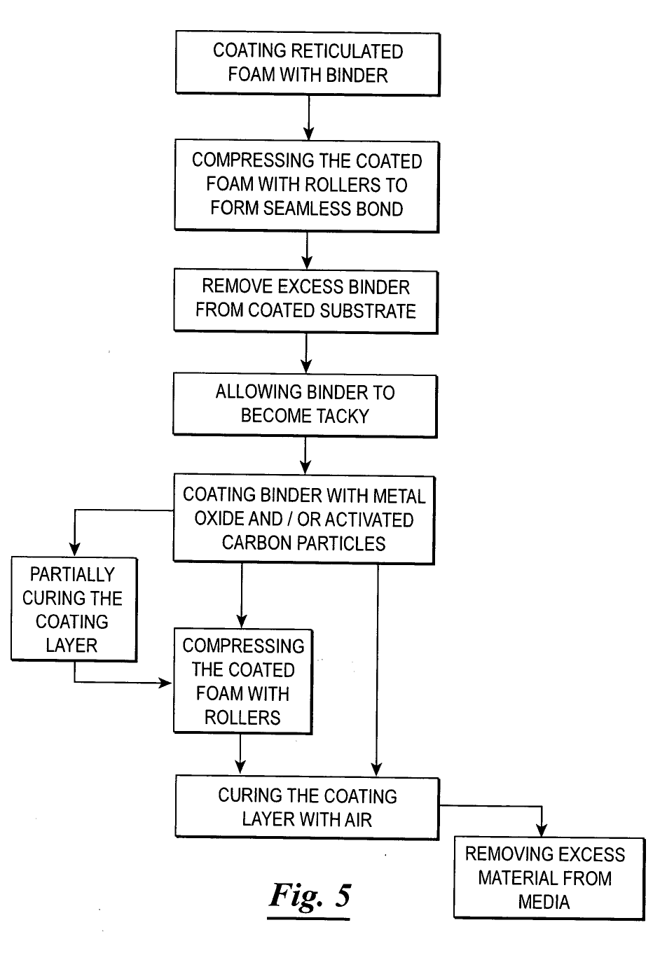

Referring now to FIGS. 4 and 5, a method for providing the flexible reticulated foam fluid media 10 of the present invention will be described. As previously stated, the method includes the steps of coating the flexible foam substrate 12 with a binder 14, compressing the coated substrate such as by compression forces using the roller device 20, removing excess binder 14 and thereby create a uniform binder layer on the surface of the flexible foam substrate 12, allowing the coated substrate surface to become tacky, coating the substrate coated with the binder 14 with a plurality of metal particles and/or carbon particles 16, subjecting the resulting coated substrate to compression forces using the roller device 20 such as a pair of adjacent rollers 20a and 20b, and curing the binder 14 on the compressed coated substrate by air drying using ambient air or heated air, and thereafter removing any excess or unbound particles 16.

The compression of the coated substrate by means of a roller or the pair of rollers 20a and 20b whereby the force of the rollers 20a and 20b presses the binder 14 into the pores of the flexible foam substrate 12, and into the irregular surface contours of the particles 16, eliminates air pockets and insures a strong uniform seamless stable bond between the flexible foam substrate 12, the binder 14 and the particles 16. As previously stated, excess binder 14 is removed from the void spaces of the flexible foam substrate 12 when the rollers 20a and 20b compress the coated substrate. The tension applied to the rollers 20a and 20b of the roller device 20 is set to optimize the compression forces applied to the flexible foam substrate 12 and is correlated to the thickness and density of the flexible foam substrate 12. For example, the roller tension is set to maintain a gap between the rollers 20a and 20b of around 0.1 to 0.3 inches, desirably about 0.15 inches, when compressing a one-inch thick coated polyethylene substrate saturated with binder and having from about 5 to 30 pores per square inch, and desirably about 15 pores per square inch. The uniformly coated substrate is then placed on a substantially flat surface for a sufficient period of time to allow the binder 14 to form a tacky surface. Any suitable device can be used to press the particle 16 of the binder 14 into the pores of the flexible foam substrate 12. However, desirable results have been obtained where a commercial wringer device equipped with a pair of adjustable rollers has been used to compress the coated foam substrates.

During this compression step, the coated reticulated foam substrate is compressed by passing the coated reticulated foam substrate through the gap between rollers 20a and 20b where the gap determines the amount of compression force applied to the coated reticulated foam substrate. The gap is set so that the hill surface of one roller 20a meshes with a valley surface of a adjacent roller 20b to assist in feeding the coated reticulated foam substrate through the roller device 20. The amount of compression force applied to the coated reticulated foam substrate is an important factor in the method of preparation of the flexible reticulated foam fluid treatment media of the present invention because too little applied force may result in a unstable bond between the flexible foam substrate 12, the binder 14 and the particle 16, and too great an applied force may damage the coating materials and close off the open pores and void spaces inherent in the flexible foam substrate 12 and thereby reduce, the porosity and surface area of the flexible reticulated foam fluid treatment media and its effectiveness use in fluid treatments.

Metal particles, metal oxides, activated carbon particles and combinations thereof, preferably in the form of a 200 mesh powder, are applied to the coated flexible foam substrate and kneaded into the void spaces of the flexible foam substrate to insure that all the surfaces of the tacky flexible foam substrate are coated with particulates. The coated flexible foam substrate is passed through the two rollers 20a and 20b of the roller device 20 to compress the coating together and into the flexible foam substrate in order to create a tight bond between the coating layer and the flexible foam substrate. The tension applied to the rollers 20a and 20b of the roller device 20 is set to optimize the compression forces applied to the coated flexible foam substrate and is correlated to the thickness and density of the coated flexible foam substrate and to the composition of the coating layer. As an example, the roller tension is set to maintain a gap between the rollers 20a and 20b of around 0.2 to 0.6 inches and preferably around 0.35 inches while compressing a one-inch thick coated polyethylene substrate saturated with binder and 200 mesh copper/zinc powder having about 15 pores per square inch. Ambient or heated air is passed through the coated substrate to dry and cure the coating layer. The cured media is shaken and tapped on a hard surface to remove all excess particulate material. The reticulated foam fluid treatment media 10 so produced has a flexible but durable sponge-like structure.

Referring now to FIG. 5, the method for producing the flexible reticulated foam fluid treatment media 10 of the present invention is illustrated. The reticulated foam substrate 12 is submerged into the liquid binder 14 for period of time effective to coat the reticulated foam substrate 12 with the binder 14 and allow the binder 14 to form a tacky surface. Excess binder 14 is removed from the void spaces of the reticulated foam substrate 12 by shaking the flexible foam substrate 12. Particles 16, e.g., 200 mesh metal powder, are applied to the coated substrate and kneaded into the void spaces of the flexible foam substrate 12 to insure that all the surfaces of the tacky flexible foam substrate are coated with the particles 16. The coated flexible foam substrate 22 is again shaken and tapped on a hard surface to remove excess particles 16, and thereafter the particle coated substrate is passed through the roller device 20 to compress the coating into the flexible foam substrate 12 in order to create a tight bond between the binder 14 and the particulate 16 and the flexible foam substrate 12. The gap between the rollers 20a and 20b of the roller device 20 is set to insure optimum compression of the coated flexible foam substrate 22 and size of the gap is correlated to the thickness and composition of the coated flexible foam substrate 22. Air is passed through the coated flexible foam substrate 22 to dry and cure the binder 14. The reticulated foam fluid treatment media 10 so produced has a flexible, but durable, sponge-like structure.

The various parameters of the flexible reticulated foam fluid treatment media 10 such as pore size and density may be varied to fit a particular treatment application. Desirably, the pore size of the flexible reticulated foam fluid treatment media 10 will range from about 10 microns to about ¼ of an inch in size, and the flexible reticulated foam fluid treatment media 10 will contain from about 10 percent to about 75 percent of the metal particles 16. For certain applications, the flexible reticulated foam fluid treatment media 10 may contain from about 5 percent to about 55 percent activated carbon.

In all aspects the flexible reticulated foam fluid treatment media 10 is soft and flexible and easily cut and shaped without damaging the particle layer to form a wide variety of shapes and sizes that lend themselves to use within an equally wide variety of pipes, conduits, ducts, skimmers, filter housings and fluid treatment devices.

In order to further illustrate the present invention, the following examples are given. However, it is to be understood that the examples are for illustrative purposes only and are not to be construed as limiting the scope of the present invention.

### EXAMPLE I

A polyethylene reticulated foam substrate with a density of around 10 pores per square inch, a thickness of approximately one inch and a diameter of around six inches is submerged into a liquid polychloroprene binder for sufficient time to coat the polyethylene substrate with an excess amount of the binder. The coated substrate is passed through the two rollers of the wringer apparatus to eliminate air pockets and create a tight bond between the binder layer and the substrate. The tension applied to the rollers of the wringer apparatus was set to maintain a gap of around 0.15 inches between the rollers during compression of the one-inch thick media. Excess binder is removed from the void spaces of the reticulated foam during compression of the foam in the wringer apparatus. The substrate coated with the binder is allowed to become tacky before application of the particulate materials to the binder. 200 mesh powder consisting of copper/zinc metal particles is applied to the coated substrate and kneaded into the void spaces of the foam to insure that all the surfaces of the tacky substrate are coated with metal particles. Air is passed through the coated substrate to dry and cure the coating layer. The cured media is shaken and tapped on a hard surface to remove all excess metal particles. The reticulated foam structured fluid treatment media so produced has a golden brown color and a flexible but durable sponge-like structure. Water from a swimming pool containing chlorine, heavy metals and algae was pumped through the flexible fluid treatment media, and the treated water was tested and determined to be substantially free of chlorine, heavy metals and microorganisms. During subsequent long term testing, swimming pool water of the same composition was continuously pumped through an eight-inch diameter disk of the flexible fluid treatment media at a rate of around 20 gallons per minute for more than six weeks. The treated water remained free of contaminants and the coating layer on the media remained intact.

### EXAMPLE II

A polyethylene reticulated foam substrate with a density of around 10 pores per square inch, a thickness of around one inch and a diameter of eight inches is submerged into a liquid polychloroprene binder for sufficient time to coat the polyethylene substrate with an excess amount of the binder. The coated substrate is passed through the two rollers of the wringer apparatus to eliminate air pockets and create a tight bond between the binder layer and the substrate. The tension applied to the rollers of the wringer apparatus was set to maintain a gap of around 0.15 inches between the rollers during compression of the one-inch thick media. Excess binder is removed from the void spaces of the reticulated foam during compression of the foam in the wringer apparatus. The substrate coated with the binder is allowed to become tacky before application of the particulate materials to the binder. 200 mesh powder consisting of copper/zinc metal particles is applied to the coated substrate and kneaded into the void spaces of the foam to insure that all the surfaces of the tacky substrate are coated with metal particles. The coated substrate is passed through the two rollers of the wringer apparatus in order to compress the coating together and into the substrate to create a tight bond between the coating layer and the substrate. The roller tension is set to maintain a gap of around 0.35 inches between the rollers of the wringer apparatus for optimum compression of the one-inch thick media. Air is passed through the coated substrate to dry and cure the coating layer. The cured media is shaken and tapped on a hard surface to remove all excess metal particles. The reticulated foam structured fluid treatment media so produced has a golden brown color and a flexible but durable sponge-like structure, and can be used to treat a wide variety of fluids.

### EXAMPLE III

A polyethylene reticulated foam substrate with a density of around 15 pores per square inch, a thickness of one inch and a diameter of around three inches is submerged into a liquid polyurethane binder for sufficient time to coat the polyethylene substrate with an excess amount of the binder. The coated substrate is passed through the two rollers of the wringer apparatus to eliminate air pockets and create a tight bond between the binder layer and the substrate. The tension applied to the rollers of the wringer apparatus was set to maintain a gap of around 0.2 inches between the rollers during compression of the one-inch thick media. Excess binder is removed from the void spaces of the reticulated foam during compression of the foam in the wringer apparatus. The substrate coated with the binder is allowed to become tacky before application of the particulate materials to the binder. 200 mesh powder consisting of KDF-55 metal particles is applied to the coated substrate and kneaded into the void spaces of the foam to insure that all the surfaces of the tacky substrate are coated with metal particles. Air is passed through the coated substrate to dry and cure the coating layer. The reticulated foam structured fluid treatment media so produced has a golden color and a flexible but durable sponge-like structure. The cured media is shaken and tapped on a hard surface to remove all excess metal particles. Potable water containing chlorine was pumped through the flexible fluid treatment media, and the treated water was tested and determined to be substantially free of chlorine. A three-inch diameter disk of the same flexible fluid treatment media was place in a filter housing and attached to a shower faucet. Hot potable water around 120 degrees F. containing around 1 ppm chlorine was intermittently pumped through the fluid treatment media at a rate of 1.5 gallons per minute for more than three months. The treated water remained free of chlorine and the

### EXAMPLE IV

A polyethylene reticulated foam substrate with a density of around 15 pores per square inch, a thickness of one inch and a diameter of around four inches is submerged into a liquid polychloroprene binder for sufficient time to coat the polyethylene substrate with an excess amount of the binder. The coated substrate is passed through the two rollers of the wringer apparatus to eliminate air pockets and create a tight bond between the binder layer and the substrate. The tension applied to the rollers of the wringer apparatus was set to maintain a gap of around 0.2 inches between the rollers during compression of the one-inch thick media. Excess binder is removed from the void spaces of the reticulated foam during compression of the foam in the wringer apparatus. The substrate coated with the binder is allowed to become tacky before application of the particulate materials to the binder. 200 mesh powder consisting of KDF-55 metal particles is applied to the coated substrate and kneaded into the void spaces of the foam to insure that all the surfaces of the tacky substrate are coated with metal particles. The coated substrate is passed through the two rollers of the wringer apparatus in order to compress the coating together and into the substrate to create a tight bond between the coating layer and the substrate. The roller tension is set to maintain a gap of around 0.45 inches between the rollers of the wringer apparatus for optimum compression of the one-inch thick media. Air is passed through the coated substrate to dry and cure the coating layer. The cured media is shaken and tapped on a hard surface to remove all excess metal particles. The reticulated foam structured fluid treatment media so produced has a golden brown color and a flexible but durable sponge-like structure, and can be used to treat a wide variety of fluids.

### EXAMPLE V

A polyethylene reticulated foam substrate with a density of 30 pores per square inch, a thickness of one inch and a diameter of four inches is submerged into a liquid polychlorinated rubber adhesive for sufficient time to coat the polyethylene substrate with the binder. The coated substrate is passed through the two rollers of the wringer apparatus to eliminate air pockets and create a tight bond between the binder layer and the substrate. The tension applied to the rollers of the wringer apparatus was set to maintain a gap of around 0.25 inches between the rollers during compression of the one-inch thick media. Excess binder is removed from the void spaces of the reticulated foam during compression of the foam in the wringer apparatus. The substrate coated with the binder is allowed to become tacky before application of the particulate materials to the binder. 200 mesh powder consisting of an intimate mixture of activated carbon particles and KDF-55 metal particles is applied to the coated substrate and kneaded into the void spaces of the foam to insure that all the surfaces of the tacky substrate are coated with the intimate mixture of particles. The coated substrate is passed through the two rollers of the wringer apparatus in order to compress the coating together and into the substrate to create a tight bond between the coating layer and the substrate. The roller tension is set to maintain a gap of around 0.50 inches between the rollers of the wringer apparatus for optimum compression of the one-inch thick media and for prevention of damage to the activated carbon particles. Air is passed through the coated substrate to dry and cure the coating layer. The cured media is shaken and tapped on a hard surface to remove all excess metal particles. The reticulated foam structured fluid treatment media so produced has a black color and a flexible but durable sponge-like structure, and is suitable for use as a catalyzed adsorbent.

### EXAMPLE VI

A polyethylene reticulated foam substrate with a density of 15 pores per square inch, a thickness of one inch and a diameter of four inches is submerged into a liquid polyurethane binder for sufficient time to coat the polyethylene substrate. The coated substrate is passed through the two rollers of the wringer apparatus to eliminate air pockets and create a tight bond between the binder layer and the substrate. The tension applied to the rollers of the wringer apparatus was set to maintain a gap of around 0.20 inches between the rollers during compression of the one-inch thick media. Excess binder is removed from the void spaces of the reticulated foam during compression of the foam in the wringer apparatus. The substrate coated with the binder is allowed to become tacky before application of the particulate materials to the binder. 200 mesh powder consisting of an intimate mixture of 70% zinc particulates and 30% copper particulates is applied to the coated substrate and kneaded into the void spaces of the foam to insure that all the surfaces of the tacky substrate are coated with the intimate mixture of metal particles. The coated substrate is passed through the two rollers of the wringer apparatus in order to compress the coating together and into the substrate to create a tight bond between the coating layer and the substrate. The roller tension is set to maintain a gap of around 0.40 inches between the rollers of the wringer apparatus for optimum compression of the one-inch thick media coated with dissimilar metals. Air is passed through the coated substrate to dry and cure the coating layer. The cured media is shaken and tapped on a hard surface to remove all excess metal particles. The reticulated foam structured fluid treatment media so produced has a gray color and a flexible but durable sponge-like structure, and is specifically formulated to control hard and soft

### EXAMPLE VII

A polyethylene reticulated foam substrate with a density of 30 pores per square inch, a thickness of two inches and a diameter of twelve inches by twelve inches is submerged into a liquid polyurethane binder for sufficient time to coat the polyethylene substrate with the binder. The coated substrate is passed through the two rollers of the wringer apparatus to eliminate air pockets and create a tight bond between the binder layer and the substrate. The tension applied to the rollers of the wringer apparatus was set to maintain a gap of around 0.25 inches between the rollers during compression of the one-inch thick media. Excess binder is removed from the void spaces of the reticulated foam during compression of the foam in the wringer apparatus. The substrate coated with the binder is allowed to become tacky before application of the particulate materials to the binder. 200 mesh powder consisting of activated carbon particles is applied to the coated substrate and kneaded into the void spaces of the foam to insure that all the surfaces of the tacky substrate are coated with the intimate mixture of particles. The coated substrate is passed through the two rollers of the wringer apparatus in order to compress the coating together and into the substrate to create a tight bond between the coating layer and the substrate. The roller tension is set to maintain a gap of around 0.70 inches between the rollers of the wringer apparatus for optimum compression of the one-inch thick media and for prevention of damage to the activated carbon particles. Air is passed through the coated substrate to dry and cure the coating layer. The cured media is shaken and tapped on a hard surface to remove all excess metal particles. The reticulated foam structured fluid treatment media so produced has a black color and a flexible but durable sponge-like structure, and is suitable for use as an adsorbent.

Certain modifications may be made to the method for producing a flexible reticulated foam fluid treatment media without departing from the present invention. For example, when it is desirable to maximize the surface area of the flexible reticulated foam fluid treatment media, while minimizing the density of the coating layer, the flexible foam substrate coated with the binder is compressed prior to applying the particles to the binder coated substrate and the selected particles is allowed to cure without further compression.

Further, in certain instances, it may be desirable to permit the binder coated flexible substrate containing the metal particles is partially cured before being compressed so as to enhance the binder material to impregnate the saturated particle coating and to allow the coating layer to become viscous before the particles are compacted by compression.

From the above description, it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and claimed.

What is claimed is:

1. A flexible reticulated foam fluid treatment media for treating fluids containing contaminates, the flexible reticulated foam fluid treatment media comprising:
a flexible porous polymeric substrate;
a binder compatible with the flexible porous polymeric substrate, the binder disposed on the flexible porous polymeric substrate to provide a layer of binder on the flexible porous polymeric substrate; and
particles secured to the flexible porous polymeric substrate via the binder, the particles adapted to substantially remove selected contaminants from fluids contacted with the flexible reticulated foam fluid treatment media.

2. The flexible reticulated foam fluid treatment media of claim 1 wherein the particles are selected from the group consisting of metal particles, metal oxide particles, activated carbon particles and mixtures thereof.

3. The flexible reticulated foam fluid treatment media of claim 2 wherein the particles have an average particle size of from about 10 mesh to about 400 mesh.

4. The flexible reticulated foam fluid treatment media of claim 3 wherein the particles have an average particle size of from about 180 mesh to about 220 mesh.

5. The flexible reticulated foam fluid treatment media of claim 2 wherein the particles are zinc/copper particles.

6. The flexible reticulated foam fluid treatment media of claim 5 wherein the zinc/copper particles have an average particle size of from about 180 mesh to about 220 mesh.

7. The flexible reticulated foam fluid treatment media of claim 2 wherein the particles are a mixture of zinc/copper particles and a plurality of at least one additional particle selected from the group consisting of an additional metal, a metal oxide, activated carbon and mixtures thereof.

8. The flexible reticulated foam fluid treatment media of claim 2 wherein the flexible porous polymeric substrate is provided with a pore density of from about 5 to about 30 pores per square inch.

9. The flexible reticulated foam fluid treatment media of claim 8 wherein the flexible porous polymeric substrate is provided with a pore size of from about 10 microns to about 0.25 inches.

10. The flexible reticulated foam fluid treatment media of claim 9 wherein one cubic inch of the flexible porous polymeric substrate has a surface area of at least about 350 square inches.

11. The flexible reticulated foam fluid treatment media of claim 10 wherein the flexible porous polymeric substrate is fabricated from a polymeric material selected from the group consisting of polyethylene, polypropylene, polyether, polystyrene, polycarbonate, polyurethane, copolymers of acrylic and non-acrylic polymers, and blends thereof.

12. The flexible reticulated foam fluid treatment media of claim 1 wherein the particles are selected from the group consisting of metal particles, metal oxide particles, activated carbon particles and mixtures thereof and wherein the amount of particles present on the flexible porous polymeric substrate is from about 10 to about 65 weight percent.

13. The flexible reticulated foam fluid treatment media of claim 1 wherein at least a portion of the particles are activated carbon particles, and wherein the amount of activated carbon particles present on the flexible porous polymeric substrate is from about 5 to about 45 weight percent.

14. A method for producing flexible reticulated foam fluid treatment media for removing contaminates from fluids, the method comprising the steps of:
providing a flexible porous polymeric substrate;
coating the flexible porous polymeric substrate with a binder compatible with the flexible porous polymeric substrate to provide a coated flexible porous polymeric substrate having a tacky surface;
applying an effective amount of particles on the tacky surface of the coated flexible porous polymeric substrate to substantially coat the tacky surface of the coated flexible porous polymeric substrate with the particles and provide a particle coated flexible porous polymeric substrate, the particles being selected from the group consisting of metal particles, metal oxide particles, activated carbon particles and combinations thereof;
compressing the particle coated flexible porous polymeric substrate to create a bond between the flexible porous polymeric substrate, the binder and the particles; and
drying the compressed particle coated flexible porous polymeric substrate to cure the binder and provide a reticulated foam fluid treatment media having a flexible, durable sponge-like structure.

15. The method for producing flexible reticulated foam fluid treatment media for removing contaminates from fluids of claim 14 wherein the reticulated foam fluid treatment media is characterized as having a plurality of pores having a pore size of from about 10 microns to about 0.25 inches and wherein the reticulated foam fluid treatment media contains from about 10 to about 75 weight percent metal particles.

16. The method for producing flexible reticulated foam fluid treatment media for removing contaminates from fluids of claim 15 wherein the reticulated foam fluid treatment media further contains from about 5 to about 55 weight percent activated carbon particles.

17. The method for producing flexible reticulated foam fluid treatment media for removing contaminates from fluids of claim 14 wherein the reticulated foam fluid treatment media is characterized as having a plurality of pores having a pore size of from about 10 microns to about 0.25 inches and wherein the reticulated foam fluid treatment media contains from about 5 to about 55 weight percent activated carbon particles.

18. The method for producing flexible reticulated foam fluid treatment media for removing contaminates from fluids of claim 14 further comprising the step of:
removing excess binder from void spaces of the flexible porous polymeric substrate prior to applying an effective amount of particles to the tacky surface of the coated flexible porous polymeric substrate.

19. The method for producing flexible reticulated foam fluid treatment media for removing contaminates from fluids of claim 15 further comprising the step of:
removing excess particles from particle coated flexible porous polymeric substrate prior to compressing the particle coated flexible porous polymeric substrate to creating a bond between the flexible porous polymeric substrate, the binder and the particles.

20. A flexible reticulated foam fluid treatment media for treating fluids containing contaminates, the flexible reticulated foam fluid treatment media comprising:
a flexible porous substrate;
a binder compatible with the flexible porous substrate, the binder disposed on the flexible porous substrate to provide a layer of binder on the flexible porous substrate; and
particles secured to the flexible porous substrate via the binder to form the flexible reticulated foam fluid treatment media, the particles selected from the group of particles consisting of metal particles, metal oxide particles, activated carbon particles and mixtures thereof.

21. The flexible reticulated foam fluid treatment media of claim 20 wherein the particles have an average particle size of from about 10 mesh to about 400 mesh.

22. The flexible reticulated foam fluid treatment media of claim 21 wherein the particles have an average particle size of from about 180 mesh to about 220 mesh.

23. The flexible reticulated foam fluid treatment media of claim 20 wherein the particles are zinc/copper particles.

24. The flexible reticulated foam fluid treatment media of claim 23 wherein the zinc/copper particles have an average particle size of from about 180 mesh to about 220 mesh.

25. The flexible reticulated foam fluid treatment media of claim 20 wherein the particles are a mixture of zine/copper particles and a plurality of at least one additional particle selected from the group consisting of an additional metal, a metal oxide, activated carbon and mixtures thereof.

26. The flexible reticulated foam fluid treatment media of claim 20 wherein the flexible porous substrate is provided with a pore density of from about 5 to about 30 pores per square inch.

27. The flexible reticulated foam fluid treatment media of claim 26 wherein the flexible porous substrate is provided with a pore size of from about 10 microns to about 0.25 inches.

28. The flexible reticulated foam fluid treatment media of claim 27 wherein one cubic inch of the flexible porous substrate has a surface area of at least about 350 square inches.

29. The flexible reticulated foam fluid treatment media of claim 28 wherein the flexible porous substrate is fabricated from a polymeric material selected from the group consisting of polyethylene, polypropylene, polyether, polystyrene, polycarbonate, polyurethane, copolymers of acrylic and non-acrylic polymers, and blends thereof.

30. The flexible reticulated foam fluid treatment media of claim 20 wherein the particles are selected from the group consisting of metal particles, metal oxide particles, activated carbon particles and mixtures thereof and wherein the amount of particles present on the flexible porous substrate is from about 10 to about 65 weight percent.

31. The flexible reticulated foam fluid treatment media of claim 20 wherein at least a portion of the particles are activated carbon particles, and wherein the amount of activated carbon particles present on the flexible porous substrate is from about 5 to about 45 weight percent.
